(19) United States
(12) Patent Application Publication
(10) Pub. No.: US 2026/0064473 A1
(43) Pub. Date: Mar. 5, 2026

(54) Ai-Driven Cross-Platform Workflow Automation Using Computer Vision And Machine Learning

(71) Applicant: Ramin Bolouri, Concord, CA (US)

(72) Inventor: Ramin Bolouri, Concord, CA (US)

(21) Appl. No.: 19/313,656

(22) Filed: Aug. 28, 2025

Related U.S. Application Data
(60) Provisional application No. 63/688,240, filed on Aug. 28, 2024.

(51) Int. Cl. G06F 9/50

(52) U.S. Cl. CPC G06F 9/5027

(57) ABSTRACT

An AI-driven robotic process automation system learns and replicates user workflows across web, desktop, and legacy applications using computer vision and machine learning. During training, the system observes user actions with visual and structural UI context, segments the sequence into reusable tasks, and synthesizes a generalized workflow model. At runtime, a hybrid locator fusing vision with DOM/accessibility metadata binds abstract actions to live controls, while a self-healing subsystem detects anomalies and applies recovery actions. A continuous learning loop updates models and task definitions from execution telemetry so automations remain effective as interfaces evolve. The result is resilient “learn-once, run-anywhere” automation that reduces brittle scripting and maintenance overhead.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING, A LARGE TABLE, OR A COMPUTER PROGRAM LISTING APPENDIX ON READ-ONLY OPTICAL DISC

Not Applicable.

### BACKGROUND OF THE INVENTION

### Field of the Invention

The invention relates to robotic process automation (RPA) and user-interface automation. More particularly, it concerns an AI-driven system that learns user workflows by observation and executes them across web, desktop, and legacy applications using computer vision (CV), machine learning (ML), context-aware task segmentation, and continuous adaptation.

### Description of the Related Art

Conventional RPA relies on brittle selectors, scripts, or coordinate replay. Even minor UI changes break automations, driving high maintenance costs. While CV and process/task mining have been explored, existing systems typically apply AI narrowly (e.g., element detection) or offline (e.g., process discovery) rather than in a closed loop that learns, executes, and adapts in production. Representative references describe screenshot-driven activity recognition and process splitting, AI/ML to mine frequent action sequences, and CV-based UI recognition and self-healing ideas; however, these teachings are fragmented and do not describe a unified system that learns from single demonstrations, segments by context, executes cross-platform, and continuously retrains from runtime outcomes as disclosed herein.

### BRIEF SUMMARY OF THE INVENTION

The invention provides an AI-driven RPA platform that: (i) records user interactions and visual context; (ii) learns generalized workflows with sequence models (e.g., LSTM/Transformer) and contextual task segmentation; (iii) executes across heterogeneous UIs using hybrid element location (vision fused with accessibility/DOM metadata) and self-healing error recovery; and (iv) adapts via a continuous learning loop that updates models and task definitions from execution telemetry. The result is resilient “learn-once, run-anywhere” automation that reduces manual programming and maintenance while remaining robust to UI drift.

### BRIEF DESCRIPTION OF THE DRAWINGS

FIG. 1 is a schematic block diagram of an AI-driven robotic process automation (RPA) system architecture, showing a capture module, workflow learning and task segmentation engine, execution engine, hybrid element locator, continuous learning module, and a centralized task repository with illustrative data flows.

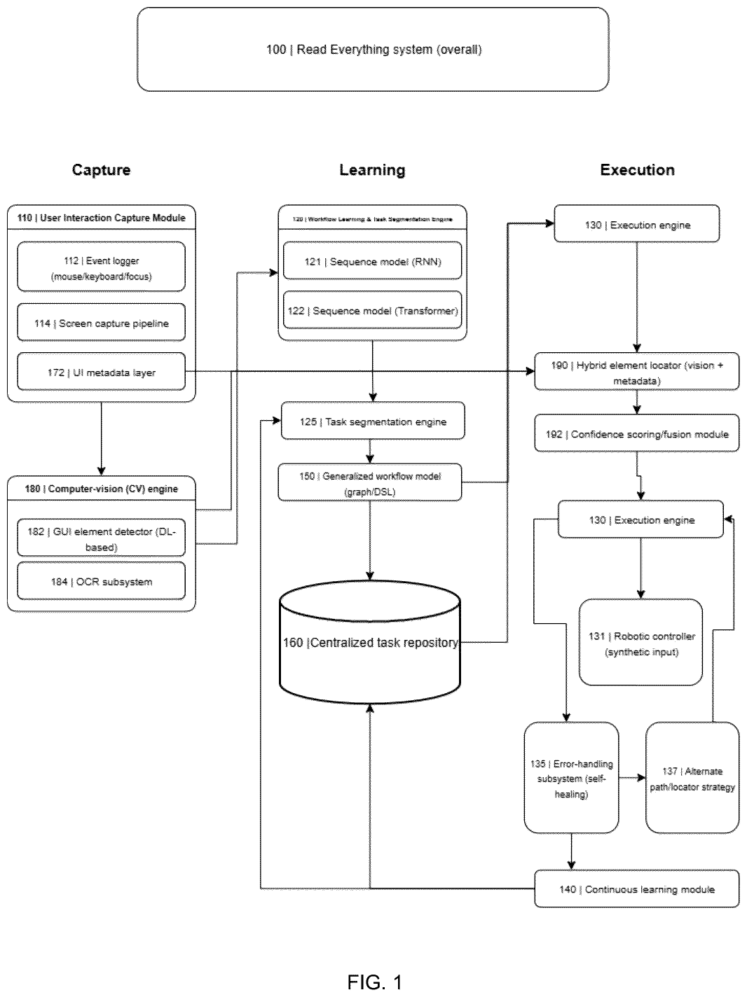

FIG. 2 is a flowchart of the training process, in which the system records user interactions, captures screen pixels and UI metadata, analyzes the UI via computer vision/OCR, segments the sequence into discrete tasks using contextual cues, and synthesizes a generalized workflow model for storage.

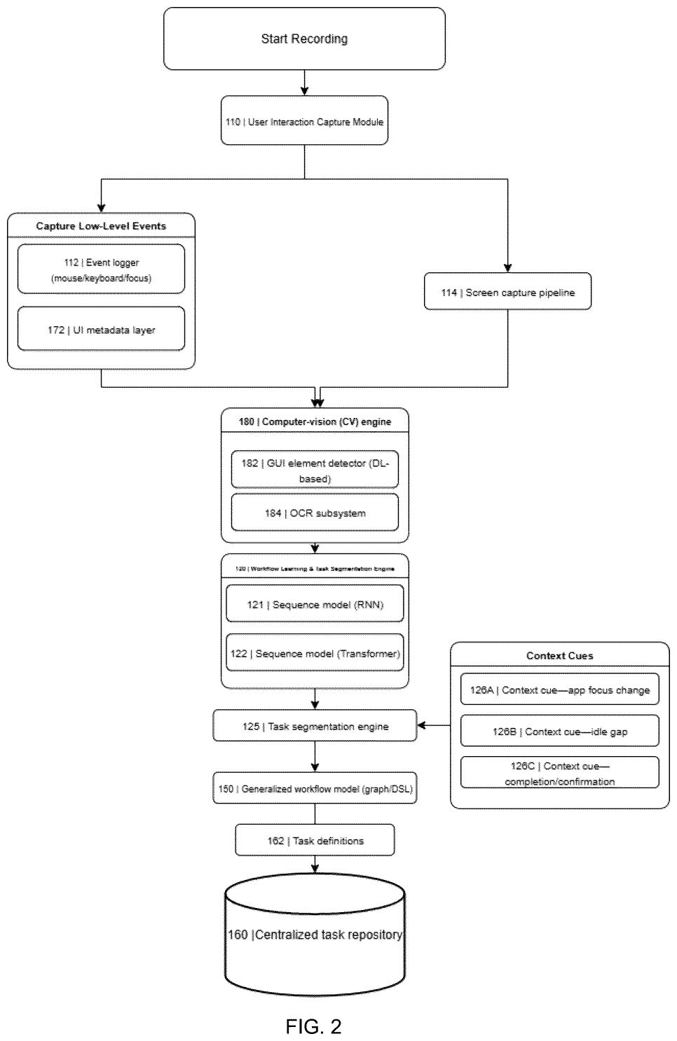

FIG. 3 is a flowchart of runtime execution showing dynamic element recognition by a hybrid locator, programmatic interaction with UI elements, anomaly detection with self-healing recovery, and feedback into continuous learning.

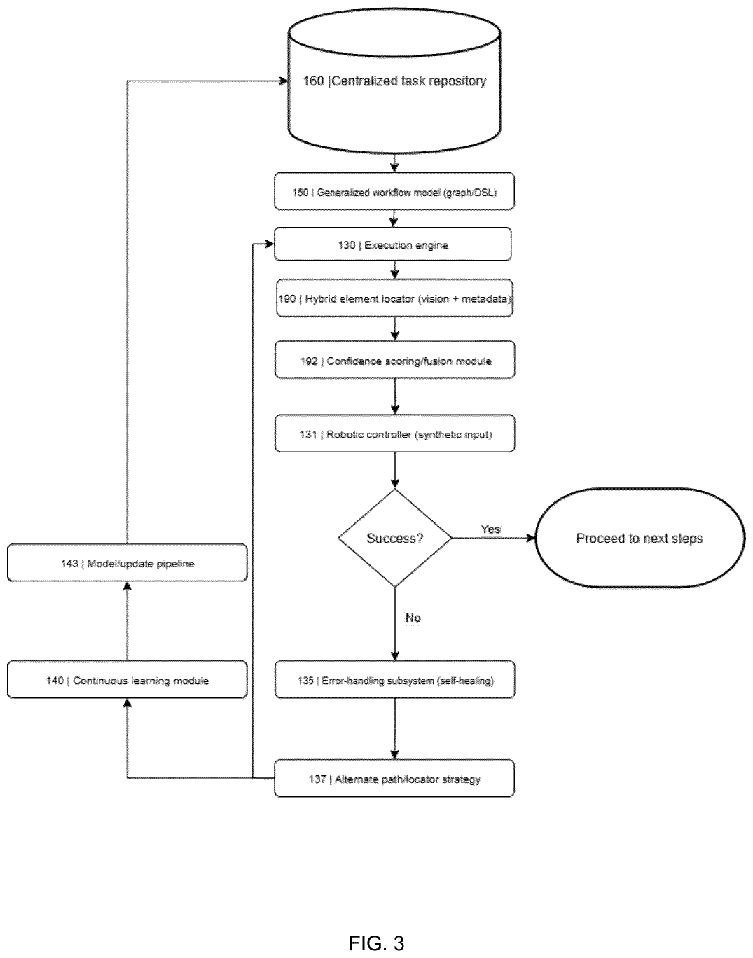

FIG. 4 is a pipeline diagram of the hybrid element locator, depicting fusion of visual analysis (computer vision and OCR) with platform UI metadata (DOM/accessibility) and confidence scoring used to bind abstract actions to live controls.

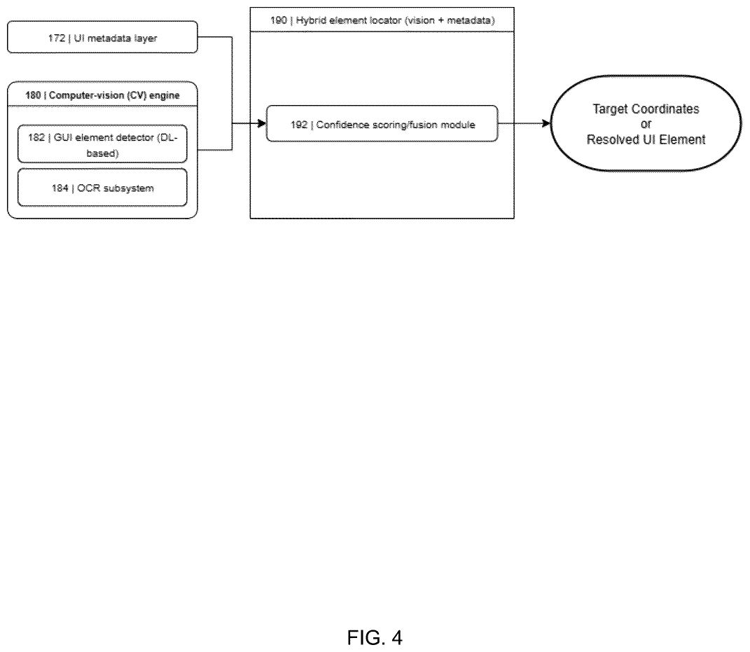

FIG. 5 is a context-aware task segmentation view illustrating timeline boundaries (e.g., app focus change, idle gap, completion cue) and formation of reusable task definitions.

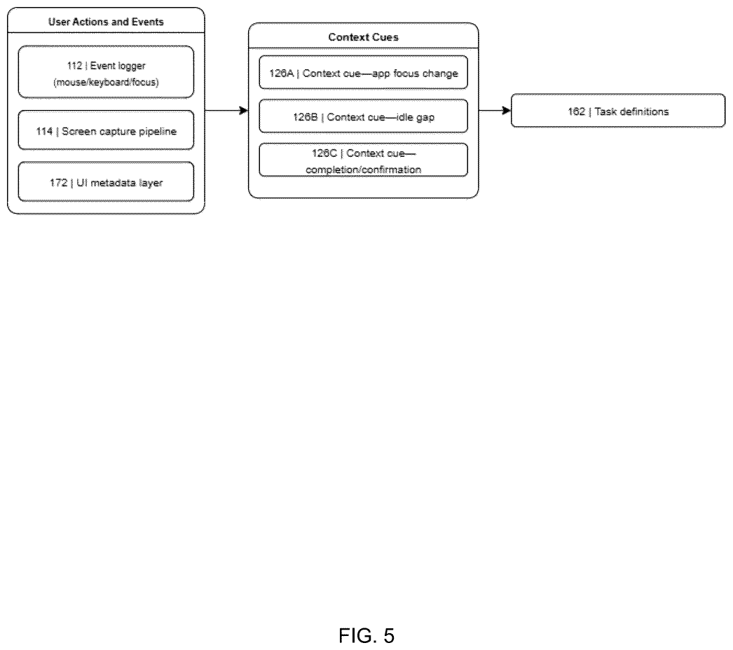

FIG. 6 is a continuous-learning loop diagram showing telemetry from executions driving model updates and repository versions that are redeployed to improve robustness over time.

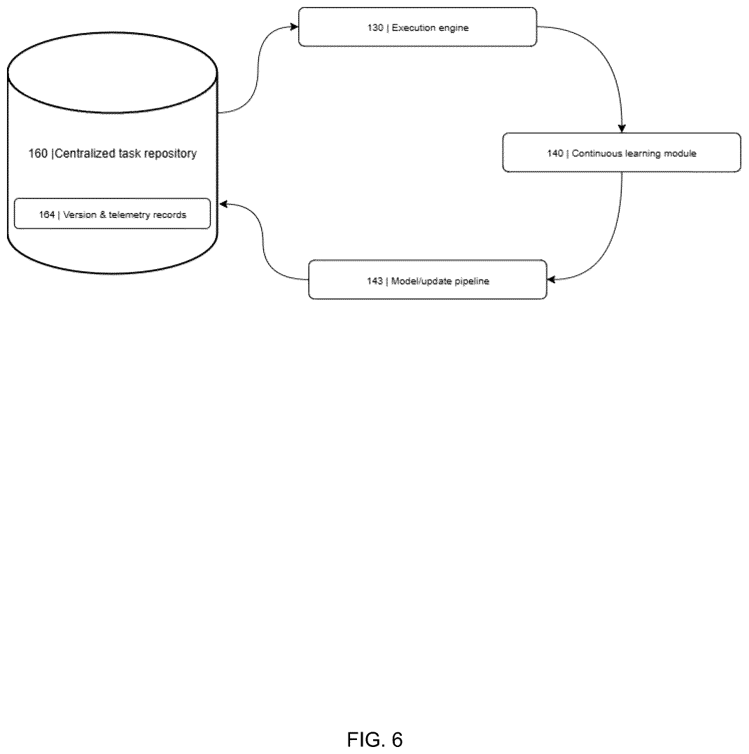

FIG. 7 is a cross-platform execution view mapping a learned workflow to heterogeneous targets (web, desktop, and legacy/terminal environments) via a binding layer enabling “learn-once, run-anywhere” automation.

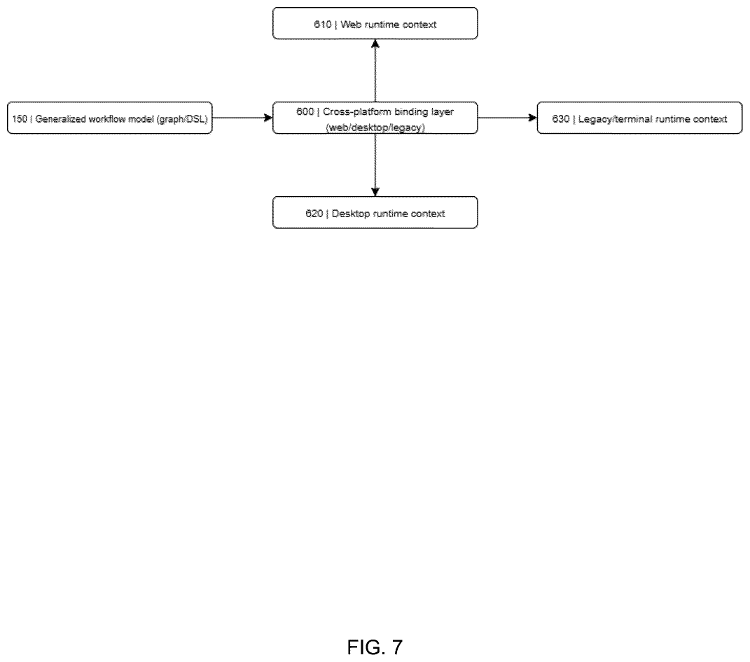

FIG. 8 is a security and privacy controls diagram showing capture-time redaction/masking of sensitive data and secure retrieval of secrets at runtime via a credential vault interface.

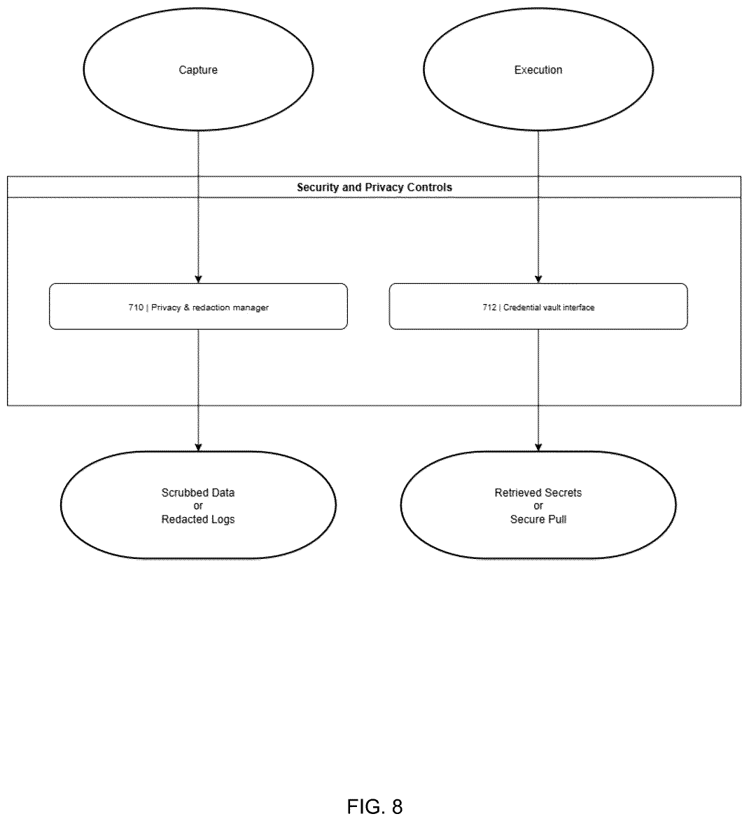

FIG. 9 is a data repository view depicting stored task definitions, version history, and telemetry suitable for reuse and fleetwide improvement.

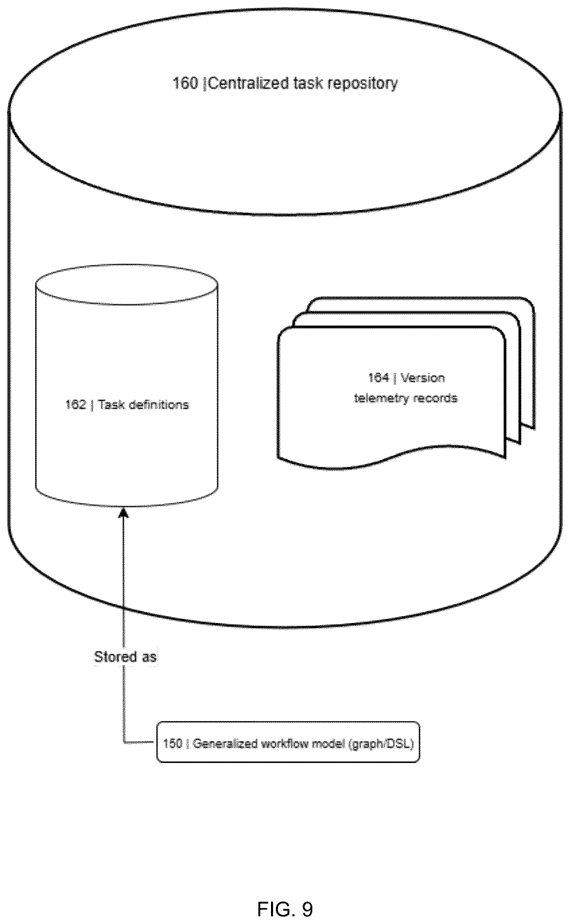

FIG. 10 is a legacy/terminal interaction view illustrating OCR-centric identification of screen regions and simulated keystroke control in environments lacking native selectors.

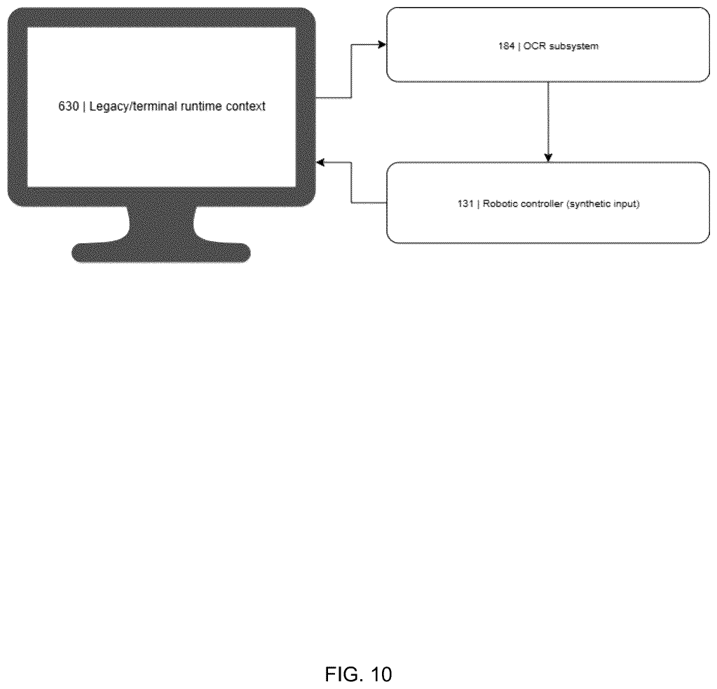

FIG. 11 is a computing environment diagram illustrating processors, memory, storage, and a non-transitory computer-readable medium storing instructions that implement the disclosed methods.

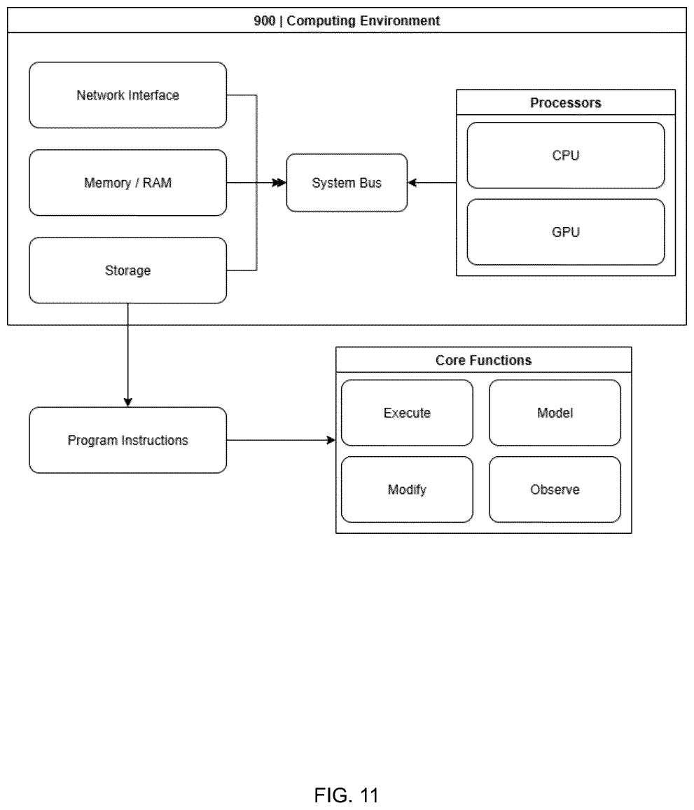

### DETAILED DESCRIPTION OF THE INVENTION

### Overview

In embodiments, the system 100 comprises: a User Interaction Capture Module 110, a Workflow Learning & Task Segmentation Engine 120, an Execution Engine 130, a Continuous Learning Module 140, and a Centralized Task Repository 160. The learning engine outputs a generalized workflow model 150 that encodes actions, parameters, conditions, and control flow. (Reference numerals are used consistently; prior inconsistencies are corrected here for clarity.)

System Architecture Capture Module 110. Records low-level input events (mouse, keyboard), window focus changes, and screen imagery. A CV sub-engine 180 performs OCR and GUI object detection (e.g., buttons, fields, icons). Where available, the module queries platform UI metadata (e.g., accessibility trees, Windows UIA, macOS AX, Linux AT-SPI, or web DOM) to augment pixel-based detection.

Workflow Learning & Task Segmentation Engine 120. Consumes time-ordered interaction streams and visual/structural context to: (i) classify actions; (ii) segment sequences into reusable tasks via context cues (application switch, idle gaps, confirmation events); and (iii) generalize constants into parameters and infer decision logic (conditions, loops). The engine trains or configures an ML sequence model (e.g., LSTM/Transformer) to represent the workflow. Output is a workflow model 150 stored in repository 160.

Execution Engine 130. Locates runtime UI elements with hybrid matching: CV (template matching, OCR, learned detectors) fused with available UI metadata (DOM/accessibility attributes) to bind abstract actions to concrete controls. It then issues synthetic input events or invokes APIs where available. A self-healing subsystem detects anomalies (element missing, timeout) and applies recovery actions: retry with backoff, alternative locator, visual re-search, keyboard shortcuts, or branch to contingency subflows.

Continuous Learning Module 140. Monitors execution telemetry and outcomes, identifies drift or recurring anomalies, and updates model 150 and repository 160 (e.g., new synonyms for a control, revised thresholds, added branches). Updates may occur online or batched, optionally with human-in-the-loop confirmation.

Centralized Task Repository 160. Stores structured task definitions, UI descriptors, version history, success/failure statistics, and training exemplars for reuse and fleetwide improvement.

### Training

Initialization. A recording session begins; capture module 110 logs actions and visual context with timestamps and active-window identifiers.

Context capture. For each action, the system persists a visual crop, OCR text, and any retrieved UI metadata, correlating to the action site.

Learning & segmentation. Engine 120 identifies repeated subsequences and contextual boundaries (e.g., app focus changes, confirmation dialogs) to define discrete tasks. It infers control structures (loops/branches) and parameterizes constants (e.g., <InvoiceNumber>).

Synthesis. The generalized workflow model 150 is rendered as a graph or DSL (nodes=actions/subtasks; edges=dependencies/branches) and persisted in 160. A human-readable preview may be surfaced for optional edits.

### Execution

Initialization. Execution engine 130 loads model 150, prepares applications (launch/navigate), and acquires any secure inputs from a vault.

Dynamic element recognition. A hybrid locator 190 combines CV 180 with DOM/accessibility to find targets robustly despite layout or attribute drift.

Actioning & control flow. The engine performs actions, evaluates runtime conditions (screen values, variables), and follows the learned branches/loops.

Legacy and remote interfaces. For terminal or remote desktops, OCR and coordinate mapping with semantic labeling enable interaction without native selectors.

Logging & telemetry. Fine-grained logs (including error screenshots) feed analytics and continuous learning 140.

### Continuous Learning & Adaptation

Exception learning. New dialogs or errors encountered at runtime trigger capture of corrective strategies (e.g., retry, alternate path), which are merged into model 150 and propagated via repository 160.

Optimization. The system may reorder steps, coalesce redundancies, or parallelize independent tasks when safe, based on aggregated execution outcomes.

Fleet sharing. Improvements learned by one bot instance become available to others via repository synchronization.

### Security and Privacy

Sensitive values (passwords, PII) are masked during capture; secrets are retrieved at runtime from a credential vault; screenshots can be redacted by policy; and logs support role-based access.

### Computing Environment

Embodiments run on general-purpose computers and/or servers; components may be co-located or distributed. A non-transitory computer-readable medium stores instructions that, when executed, implement the methods herein.

### Best Mode (at Time of Filing)

A preferred embodiment uses: (i) Transformer-based sequence modeling (12-layer encoder with positional encoding over action tokens and UI-state embeddings); (ii) a CV stack with OCR and a GUI-element detector fine-tuned from a general object-detection backbone on annotated screen images; (iii) hybrid element fusion that scores candidates using a weighted sum of CV similarity and DOM/accessibility attributes; (iv) anomaly handlers prioritizing low-risk retries, then alternate locators, then user cueing; and (v) repository-driven A/B evaluation of model updates before fleet rollout. Hyperparameters and training recipes are selected to maximize recall of target elements at given latency constraints.

### Alternative Embodiments

Sequence learners can be LSTM or GRU; CV may rely on template matching where ML is unavailable; the system may prefer native APIs where present and fall back to CV elsewhere; and on-device, edge, or cloud training may be used depending on privacy and performance needs.

### Advantages Over the Prior Art

Unlike systems that only mine logs or only add CV selectors, this platform integrates context-aware segmentation, deep sequence learning, cross-platform hybrid element binding, and a closed feedback loop that updates both models and task definitions from runtime experience.

1. A computer-implemented method for automatically learning and executing a user workflow across one or more applications, the method comprising: capturing images of a graphical user interface during performance of the user workflow and retrieving user-interface element information via operating-system or application programming interfaces; analyzing, by a computer-vision module, the images and the user-interface element information to recognize user-interface elements; monitoring and recording user input actions associated with the recognized user-interface elements; training or configuring a machine-learning model using the recorded actions in sequence to learn an ordered sequence of actions constituting the user workflow; automatically determining, via contextual analysis of the sequence of actions and interface states, boundaries that divide the sequence into one or more discrete reusable tasks; storing a representation of the ordered sequence of actions for each discrete task; and automatically executing at least one of the discrete tasks on a target computing environment by programmatically interacting with the recognized user-interface elements, including detecting an execution anomaly and, in response, adjusting execution using an alternative action or updated element identifier, and updating the machine-learning model based on the adjusted execution.

2. The method of claim 1, wherein capturing the images comprises screenshotting the display and concurrently obtaining metadata about active UI elements from an accessibility framework or Document Object Model such that both pixel data and structural data are used in identifying the user-interface elements.

3. The method of claim 1, wherein the machine-learning model comprises a recurrent neural network or a Transformer-based neural network trained to predict subsequent user actions based on preceding actions and interface contexts.

4. The method of claim 1, wherein determining boundaries includes detecting a change in context indicated by at least one of: a new application window receiving focus, a significant idle gap between actions, or appearance of a completion confirmation.

5. The method of claim 1, wherein executing includes sending synthetic input events and, if a target user-interface element is not found or an action fails, invoking a predefined error-handling routine selected from: searching the screen for a visually similar element using the computer-vision module, attempting an alternate interaction path, or retrying with backoff.

6. The method of claim 1, further comprising continuously retraining or updating the machine-learning model as additional instances of the workflow are executed or as the user interface changes, such that the model adapts by incorporating new training examples derived from each executed task.

7. The method of claim 1, further comprising storing each discrete task in a centralized repository as structured data including the sequence of actions, parameters, and identifiers of the user-interface elements, the repository providing version history and training data for model improvement.

8. The method of claim 1, wherein locating user-interface elements includes using a deep-learning object-detection algorithm that recognizes controls regardless of changes in position, size, or color.

9. The method of claim 1, further comprising masking or anonymizing sensitive user inputs during capture and retrieving secrets securely at runtime from a credential vault.

10. An AI-driven robotic process automation system for learning and executing user tasks, the system comprising: a computer-vision module configured to capture screenshots of graphical user interfaces and to analyze the screenshots in conjunction with platform-specific UI metadata to recognize and locate user-interface elements within one or more applications; an action-learning module comprising a machine-learning model configured to receive a time-ordered sequence of user interactions and to learn a representation of a task by modeling the sequence; a task-segmentation engine configured to delineate boundaries between distinct tasks using contextual cues to produce discrete task definitions; an execution engine configured to replicate interactions of the discrete task definitions on target computing environments and including an error-handling subsystem that detects when a target user-interface element or expected response is not present and automatically applies a recovery action; a continuous-learning module configured to monitor performance and, upon detection of a failure or a change in the user interface, trigger an update or retraining of the machine-learning model;
and a centralized data repository storing structured data for each learned task including identifiers for user-interface elements, action sequences, and version information.

11. The system of claim 10, wherein the computer-vision module comprises a trained deep neural network adapted for GUI imagery to identify buttons, text fields, icons, and other controls.

12. The system of claim 10, wherein the action-learning module's machine-learning model is an LSTM-based recurrent neural network or a Transformer network.

13. The system of claim 10, wherein the continuous-learning module automatically initiates retraining when an anomaly threshold is exceeded and updates stored task definitions with new element identifiers or modified action steps.

14. The system of claim 10, wherein a capture module correlates screenshots or pixel data with low-level input events obtained via operating-system hooks to map each user action to a specific location and element on the screen.

15. The system of claim 10, wherein the centralized repository stores success/failure telemetry and supports reuse across multiple robot instances.

16. The system of claim 10, wherein the system executes a workflow learned on a first platform on a second platform by binding abstract actions to runtime user-interface elements using hybrid visual-and-metadata matching.

17. A non-transitory computer-readable medium storing instructions that, when executed by one or more processors, cause performance of a method comprising: observing and recording a user performing a workflow across multiple applications including capturing screen data and input events; processing the recording with a machine-learning algorithm to determine an ordered sequence of actions with at least one conditional branch or loop and creating a generalized representation of the workflow; saving the generalized representation; executing the generalized representation without user intervention by identifying interface elements through image analysis and issuing synthetic input events; and automatically modifying the generalized representation upon detecting changes or errors during execution by incorporating additional branches or updated recognition data.

18. The non-transitory computer-readable medium of claim 17, wherein processing includes invoking a pre-trained deep neural network to classify user actions and to predict relationships between actions used to form conditional branches.

19. The non-transitory computer-readable medium of claim 17, wherein executing includes interfacing with an application programming interface when available and defaulting to simulated user-interface interactions via computer vision when no direct API is available.

20. The non-transitory computer-readable medium of claim 17, wherein observing and recording includes masking sensitive data during capture and securely retrieving required secrets at runtime.
